(19) United States
(12) Patent Application Publication
(10) Pub. No.: US 2016/0171866 A1
(43) Pub. Date: Jun. 16, 2016

(54) SYSTEM AND METHOD FOR AUTOMATED TRIGGERING AND MANAGEMENT OF ALARMS

(71) Applicant: DomoSafety SA, Ecublens, VD (CH)

(72) Inventors: Guillaume DUPASQUIER, Geneva (CH); Edouard GOUPY, Lausanne (CH)

(21) Appl. No.: 14/781,521

(22) PCT Filed: Apr. 22, 2013
(86) PCT No.: PCT/EP2013/058308

§ 371 Date: Sep. 30, 2015

(51) Int. Cl. G08B 21/04; H04L 29/08; H04W 4/00

(52) U.S. Cl. CPC G08B 21/0461; H04W 4/008; H04L 67/12; H04W 84/04

(57) ABSTRACT

The present invention relates to a system and to a corresponding method for an automated triggering and management of alarms, in particular in a home environment (1), comprising at least one sensor (21, 22, . . . ) for collecting data and for transmitting the collected data over at least one first data connection (31, 32, . . . ) to a central unit (4), in which the central unit (4) comprises at least one receiving module (41) for receiving transmitted data and for forwarding the received data to an analyzing module (42), the analyzing module (42) being capable of comparing the received data with data stored in the analyzing module (42) and, forwarding the received data to a triggering module (43) for triggering at least one predetermined alarm as a function of the data received from the analyzing module (42) if the received data matches data stored in the analyzing module (42), or forwarding the received data to central processing equipment (6) over a second data connection (51) if the received data does not match data stored in the analyzing module (42).

### TECHNICAL FIELD OF THE INVENTION

The present invention relates to the general field of alarm systems and methods. More precisely, the present invention relates to a system and a corresponding method for automated triggering and management of alarms. In particular, this invention relates to a system and a corresponding method for an automated triggering and management of alarms, in particular in a home environment, comprising at least one sensor for collecting data and for transmitting the collected data over at least one first data connection to a central unit.

### STATE OF THE ART

Systems and method for domestic safety and care for elderly have received a growing focus in recent years, due to the prolonged life expectancy, the desire of autonomy of elderly people as well as the foreseen public health costs explosion. The aging process generally impacts the physical and mental abilities of an individual. A large proportion of elderly people live alone without any supervision and have difficulties in performing simple tasks. In case of any incident, these people need a way to warn a supervisor (family, close relatives, neighbors, doctor, etc.) of the situation and request help.

Moreover, despite much progress in home safety during the last decades, domestic accidents statistically remain one of the major sources of death, serious injuries and expensive costs. In particular, people with limited autonomy are more exposed to domestic accidents, for example to fire or flood, because they are statistically more likely to forget to switch off hot electrical devices (cooking plate, iron, . . . ) or to forget to turn off the water.

Very similar is the situation for other temporarily or permanently disabled people, such as patients who leave the hospital before being completely reestablished and who can stay at home alone during a certain period of time, with a reduced mobility and cognition abilities (e.g. due to medicine which they must take).

Today, the existing systems for care and/or assistance at distance are basically limited to pure emergency systems. In particular, all current systems are based on panic buttons which must be activated manually by the user of the system in order to trigger an alarm for having alarm information transmitted to assistance personnel. In some more sophisticated systems, the manual pressing of an emergency button in case of emergency can be replaced by a system which requires users to activate a button (or a similar device) at certain regular time intervals in order to stop an alarm which is otherwise triggered automatically. This second type of systems is mainly based on different types of timers or other kinds of time controlled electricity switches. Examples are absolute time programmable power switches, user configurable relative time auto shut-off (standard timers), remote controlled power switches, etc.

The big disadvantages of such systems are, on the one hand, the fact that manual trigger systems cannot protect a person who is either unconscious or unaware of a dangerous event (e.g. an elderly person who leaves the cooking plate switched on before going to bed). On the other hand, these existing solutions are stigmatizing and their acceptance is difficult.

Another type of existing solutions is mainly focusing on hospital environments (i.e. beds) or on the manner employed for actually detecting the physical absence or presence of a person. These solutions, although being useful in some situations, cannot be used successfully in home environments as they do not take into account the habits of the user of the system. More particularly, the conventional systems do not at all allow for a dynamic behavioral analysis of users, for example a detection of abnormal behavior, and triggering of corresponding alarms based on the detected abnormal behavior condition.

Furthermore, as of today, there are virtually no systems for domestic care and assistance providing multiple home-automation and safety functions, that can be installed virtually in any house and which stay fully operational even after a failure of the power grid.

### DISCLOSURE OF INVENTION

It is therefore an objective of this invention to propose a new and improved system and a new and improved corresponding method for an automated triggering and management of alarms, in particular in a home environment, that does not present the above-mentioned inconveniences and disadvantages of the prior art.

According to the present invention, these and other objectives are achieved in particular through the features of the independent claims. In addition, further advantageous embodiments follow from the dependent claims and the description.

In particular, this objective is achieved through the invention in that, in a system for an automated triggering and management of alarms, in particular in a home environment, comprising at least one sensor for collecting data and a data connection for transmitting the collected data to a central unit, the central unit comprises at least one receiving module for receiving transmitted data and for forwarding the received data to an analyzing module, the analyzing module being capable of comparing the received data with data stored in the analyzing module and, forwarding the received data to a triggering module for triggering at least one predetermined alarm as a function of the data received from the analyzing module if the received data matches data stored in the analyzing module, or forwarding the received data to central processing equipment over a second data connection if the received data does not match data stored in the analyzing module.

The advantage of this invention resides, among other things, in the fact that the data collected by the at least one sensor are transmitted to a central unit which comprises an analyzing module which is capable of comparing the received data with data stored in the analyzing module and triggering at least one predetermined alarm if the received data matches the stored data. In particular, data received from particularly critical sensors (e.g. fire sensor, inundation sensor, etc.) can automatically and urgently trigger an alarm which consists in a phone call to the emergency service (e.g. police, fire brigade, or similar), as a function of the received data. If this is not the case, i.e. if the received data does not match data stored in the analyzing module, the received data can be forwarded to the central processing equipment for further processing. In this way, emergency situations can be detected quickly and a required reaction can be triggered without any delay.

In an embodiment of the present invention, the central unit further comprises at least one physical interface for manual triggering of a predetermined alarm. The physical interfaces for manual triggering of predetermined alarms can in particular be buttons, levers or similar devices which can easily be activated by the system users. In a preferable implementation of this embodiment, the base unit can comprise two or three buttons, one of which being for example an emergency button for manual triggering of an immediate emergency alarm. This alarm can be a phone call to the police, to an ambulance or to any other similar emergency service. Activating any one of the other interfaces can for example trigger a phone call to a predetermined person (e.g. a relative of the user or a specialized home care professional). Of course, any other combination of physical interfaces and corresponding alarms is also imaginable.

In an embodiment of the present invention, the first data connection is a wireless data connection, in particular WiFi, ZigBee or Bluetooth. However, it is easily understandable that other wireless technologies can be used instead of the cited technologies. This embodiment has the advantage, among other things, that sensors in the system can be distributed within the monitored environment without any physical restriction since the collected data can be transmitted to the central unit in an easy way. The use of wireless technologies such as WiFi, ZigBee or Bluetooth allows for use of standardized tools which also guarantees compatibility with other equipment.

In a further embodiment of the present invention, the second data connection is a wireless data connection, in particular a GPRS, UMTS or LTE connection. Similarly to the previous embodiment, this embodiment has also the advantage, among other things, that the use of wireless technologies for data transfer such as GPRS, UMTS or LTE allows for use of standardized tools which also guarantees compatibility with other equipment. Moreover, the flexibility of wireless connections allows for positioning the central unit and the central processing equipment in a way fully independent from each other. In particular, it allows also the central unit to be placed very close to the sensors while the central processing equipment is positioned at a remote location.

In another embodiment of the present invention, the central unit comprises a timer module for determining the time for forwarding the received data to the central processing equipment. In particular, the timer module can be preprogrammed in such a way that data are forwarded to the central processing equipment only at regular time intervals (e.g. every five, ten or fifteen minutes). Of course, other time intervals are also possible. Such a solution allows, inter alia, for an optimized use of energy resources of the central unit since data connection between the central unit and the central processing equipment is activated only at certain time intervals and only if data are to be sent to the central processing equipment. Otherwise, the central unit can remain in an energy-saving (or standby) mode.

In a further preferred embodiment of the present invention, the central processing equipment comprises a first database for storing data received from the central unit and a second database for storing predetermined reference data. The particular advantage of this embodiment of the present invention is, among other things, that the data received from the central unit can be stored in the central processing equipment separately from the data which are used as reference for further analysis. Furthermore, the access to the stored received data in the first database can be granted separately from the access to the reference data. Also, the received data can be analyzed and used in a preferred way and at the preferred time.

In another preferred embodiment of the present invention, the central processing equipment comprises an analyzing module for comparing the data stored in the first database with the data stored in the second database and for triggering at least one predetermined alarm if the compared data match each other. Data matching in the sense of the present invention does not need to be understood in the literal meaning of the term, i.e. a positive match of data can also be attained if a predetermined rule from an expert system is fulfilled in an appropriate manner. In particular, the “matching” of data in the present sense can also be given if the compared data values are found to be below or above any particular threshold. While this particular threshold can be a fixed value, it would also be imaginable to use a dynamic threshold value, determined based on past data or health profile of the user. The advantage of this invention resides, among other things, in the fact that the central processing equipment can use the data received from the central unit, i.e. the data collected by the at least one sensor and forwarded to the central processing equipment in order to trigger further alarms, i.e. alarms that were not triggered by the central unit itself. For example, while the central unit can be in charge of triggering very urgent alarms (emergency cases), the central processing equipment can be in charge of triggering all less urgent alarms, for example alarms related to changes in behavior of users of the system. All other combinations of alarm triggering sharing between the central unit and the central processing equipment are of course also possible.

Finally, in another preferred embodiment of the present invention the central processing equipment comprises a displaying module for displaying at least a part of data stored in the first database of the central processing equipment via a graphical user interface, in particular a graphical user interface capable of being accessed by means of a web browser or any other suitable application. This embodiment of the present invention has the advantage, among other things, that the data stored in the first database of the central processing equipment can be visualized and accessed by remote users of the system. If a web-based graphical user interface is used, the data collected by the sensors, transmitted to the central unit and forwarded to the central processing equipment, can be represented such that they can be easily consulted by any authorized person. In particular, this embodiment allows e.g. for specialized care professionals to access vital information about the user of the system in the home environment such that these parameters can easily be monitored from a remote location. However, any other appropriate type of user interface (including not-graphical user interfaces) can also be used instead.

In a more general manner, the system according to the invention allows also that collected data be static and simple (e.g. the information about the current state of the cooking plate or oven) while the analyzed data are dynamic and more complex (e.g. the user has not eaten any warm dishes since yesterday). This system is therefore also suitable for triggering alarms based on the analysis of the behavior characteristics of the user.

At this point, it should be also stated that, besides the system for an automated triggering and management of alarms, in particular in a home environment, according to the above-identified embodiments of the invention, the present invention equally relates to a corresponding method for an automated triggering and management of alarms.

### BRIEF DESCRIPTION OF DRAWINGS

The present invention will be explained in more detail, by way of example, with reference to the drawings in which:

FIG. 1 is a schematic representation of an environment with the system for an automated triggering and management of alarms according to an embodiment of the present invention;

FIG. 2 is a schematic block diagram representation of the components of the system for an automated triggering and management of alarms according to an embodiment of the present invention;

FIG. 3 is a schematic representation of the central unit in the system for an automated triggering and management of alarms according to an embodiment of the present invention;

FIG. 4 is a schematic representation of the central processing equipment in the system for an automated triggering and management of alarms according to an embodiment of the present invention; and

FIG. 5 is a simplified representation of a graphical user interface in the system for an automated triggering and management of alarms according to an embodiment of the present invention.

### DESCRIPTION OF SPECIFIC EMBODIMENTS OF THE INVENTION

FIG. 1 illustrates schematically an environment with the system for an automated triggering and management of alarms according to a first embodiment of the present invention. The environment used for illustration in FIG. 1 is a home environment and it is symbolized only in a simplified manner, being represented by a ground plan of a flat with usual rooms, i.e. with a living room, kitchen, bedroom, bath/toilette and a balcony. Of course, any other environment and in particular any other home environment can be used instead.

A number of sensors 21, 22, 23, . . . are distributed at different points in this home environment. The different sensors 21, 22, 23, . . . are capable of collecting data, as a function of their position, type and/or adjustment. Examples of sensors 21, 22, 23, . . . which can be used in the system according to the present invention comprise in particular standard sensors used in known systems for monitoring home environments, e.g. smoke sensors, temperature sensors, flood sensors, gas sensors, etc., but also particular sensors that can be used for monitoring behavior of system users and for detecting abnormal behavioral situations, in particular bed sensors, i.e. captors of pressure that react when someone is lying down on the bed, motion detection, i.e. infrared (or similar) sensors reacting when someone is located in a specific room, armchair sensors, i.e. sensors of pressure that react when someone is seated in the armchair, door/window sensors, i.e. sensors that can react as a function of the fact that a particular door or window is opened or closed, stove/oven sensors, i.e. sensors that detect the on or off state and power consumption of the cooking stove and/or kitchen oven, water sensors, i.e. sensors that can grasp the information if the water tap has been opened or closed, and/or the information about the water consumption, etc. Different possible implementations of the system according to the present invention, and the particular use of the different sensors will be described further down.

Although the schematic representation of the system according to an embodiment of the present invention shows a number of sensors 21, 22, 23, . . . , it is also clear that this system can also comprise one single sensor, i.e. the fire or smoke sensor.

The system according to an embodiment of the present invention illustrated in FIG. 1 also comprises a central unit 4, represented schematically by a small device with an antenna in the lower right corner. Also represented in FIG. 1 are different data connections 31, 32, 33, . . . between the individual sensors 21, 22, 23, . . . and the central unit 4. Basically, each sensor 21, 22, 23, . . . is connected to the central unit 4 by means of at least one data connection 31, 32, 33, . . . such that the data collected by the sensors 21, 22, 23, . . . can be transmitted to the central unit 4. Of course, it is also imaginable that more than one data connection 31, 32, 33, . . . is provided between one particular sensor 21, 22, 23, . . . and the central unit 4.

The data connections 31, 32, 33, . . . can in particular be wireless data connections for near communication such as WiFi, ZigBee or Bluetooth. Of course, this invention is not limited to these technologies only. Thus, it is also possible to foresee sensors 21, 22, 23, . . . which are connected to the central unit 4 by means of some other wireless (for example GPRS, UMTS, LTE) or wired connections (such as Ethernet).

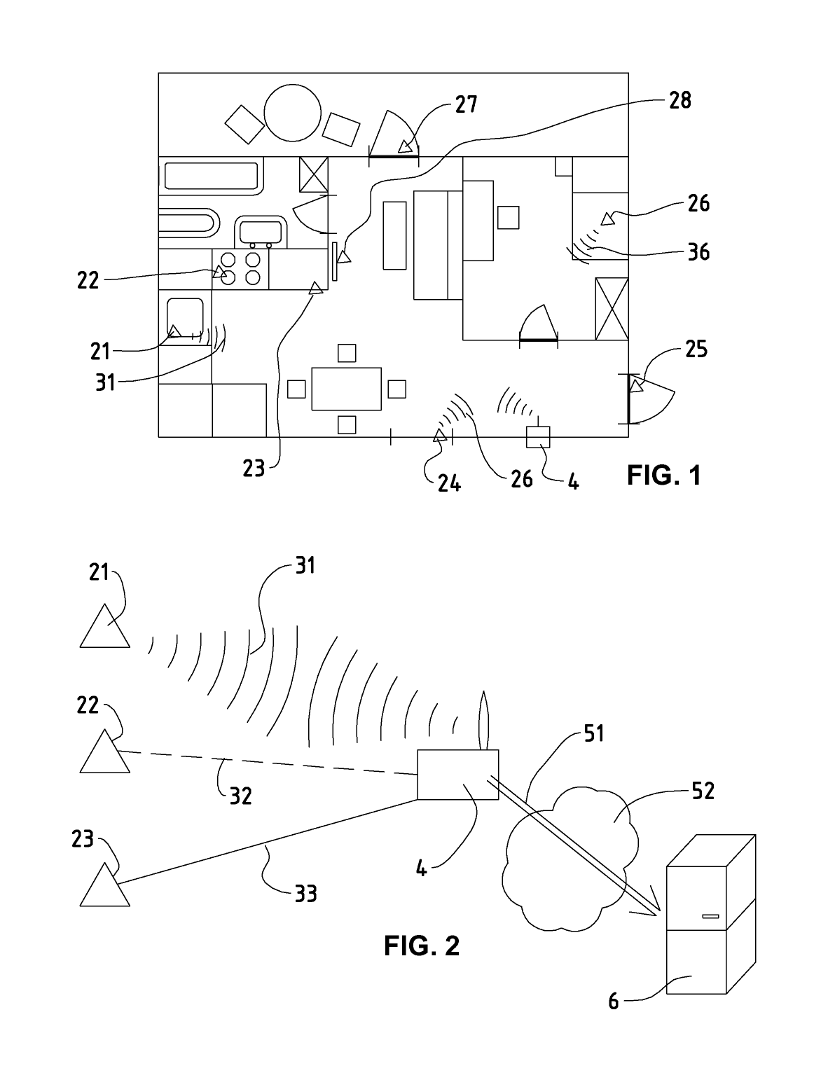

FIG. 2 shows in a schematic way the different components of the system for an automated triggering and management of alarms according to an embodiment of the present invention, for example the system from FIG. 1. In FIG. 2, the sensors 21, 22, 23, . . . are represented schematically by small triangles. As already mentioned, the sensors 21, 22, 23, . . . can comprise different sensor types, in particular “classical” sensors such as smoke sensors, temperature sensors, flood sensors or gas sensors, but also particular sensors that can be used for monitoring behavior of system users, for example bed sensors, armchair sensors, stove/oven sensors, water tap sensors, etc. Each sensor 21, 22, 23, . . . is connected to the central unit 4 through a corresponding data connection 31, 32, 33, . . . . Since the data connections 31, 32, 33, . . . can be of many different types, each one of them in FIG. 2 is represented using a different type line. Of course, it is also imaginable that all data connections 31, 32, 33, . . . are of the same type, but the present invention is of course not limited thereto, and it is absolutely possible to provide different type connections 31, 32, 33, . . . for each individual sensor 21, 22, 23, . . . .

To take an example, the sensor 21 can be a well-known smoke sensor. This smoke sensor 21 can be used to gather information about the presence of smoke in the monitored environment. Thus, this smoke sensor 21 will be constantly waiting for smoke and, if smoke is eventually detected, the smoke sensor 21 will send the corresponding information to the central unit 4 over the data connection 31. Depending on the required application, the smoke sensor 21 can be more sophisticated and transfer not only simple binary information about the presence or absence of smoke, but can also gather and transmit additional information such as, for example, the smoke concentration, the nature of smoke, etc. In another example, the sensor 22 can be a door sensor, associated with the fridge door. This door sensor 22 can therefore detect the situation in which the door of the fridge has been opened. If such a situation is detected, the door sensor 22 can send the corresponding information to the central unit 4 by means of the corresponding data connection 23. Of course, it would easily be possible to integrate a timer into the door sensor 22 such that the information about the open state of the fridge door is only transmitted to the central unit 4 if the door has not been closed after a predetermined time (e.g. after 30 seconds or similar). Nonetheless, it would also be possible to provide such timers in the central unit 4 (cf. below) or even somewhere else in the system according to the present invention. A skilled person will easily realize that the different sensors 21, 22, 23, . . . can detect and transmit a plurality of data as a function of the particular use requirements.

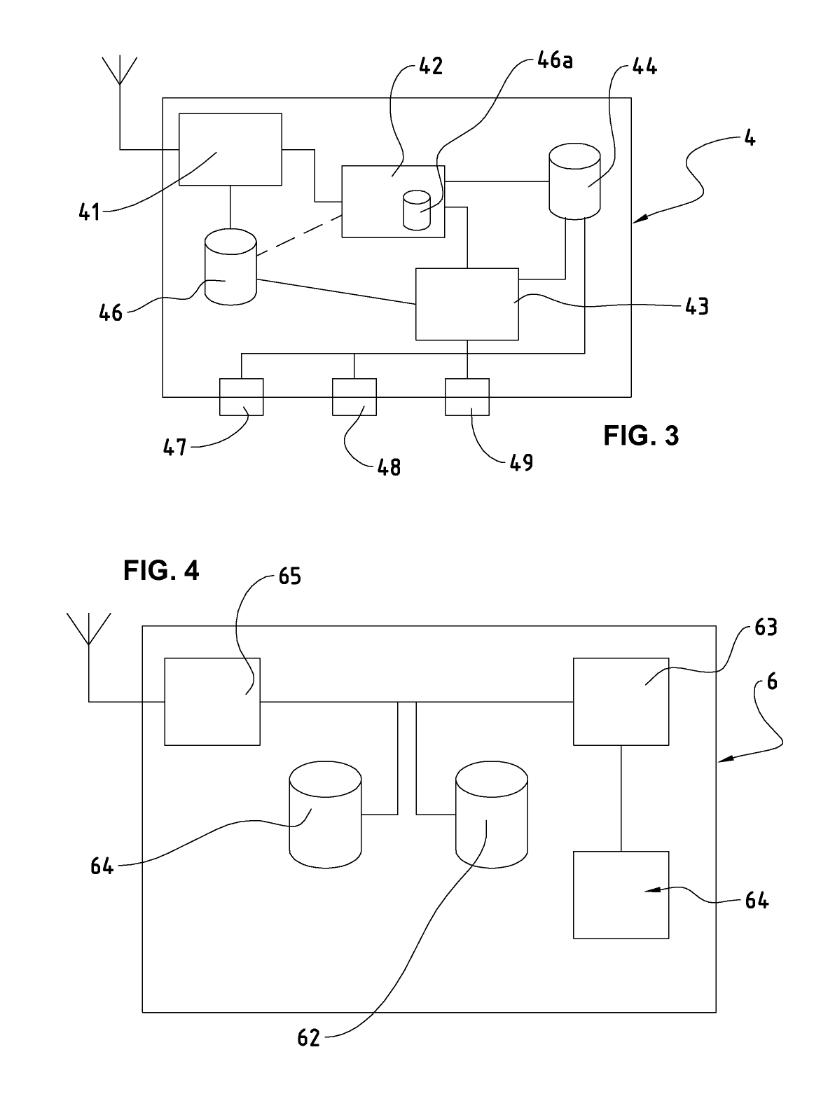

The structure and the function of the central unit 4 are described in more detail with respect to FIG. 3.

Basically, the central unit 4 comprises at least one receiving module 41 for receiving data which are transmitted from the sensors 21, 22, 23, . . . over the respective data connection 31, 32, 33, . . . . It is directly understandable that the central unit 4 can comprise as many receiving modules 41 as necessary so as to be capable of receiving data over different data transfer technologies (for example a ZigBee receiving module, a Bluetooth receiving module, etc.). However, it is also imaginable to provide one single receiving module 41 capable of receiving data over different data connections 31, 32, 33, . . . .

After transferred data have been received by the receiving module(s) 41 of the central unit 4, these data are forwarded to an analyzing module 42 of the central unit. The analyzing module 42 is in particular capable of comparing the received data with data stored in the analyzing module 42 (to this end, a small database icon 46a is represented schematically within the box representing the analyzing module 42 in FIG. 3). Of course, it would also be possible to provide for an independent database 46, i.e. a database which is not fully integrated into the analyzing module 42, but which can seamlessly transmit data to and from the analyzing module 42. If required, both the receiving module 41 and the triggering module 43 can also access the database 46. This database 46 can also be used to log information. A particular external read/write interface (not represented in FIG. 3) can also be provided either at the database 46 or at the database 46a or at both databases 46 and 46a.

If the received data matches data stored in the analyzing module 42, the analyzing module 42 forwards data to a triggering module 43 where at least one predetermined alarm is triggered as a function of this data. However, data matching in the sense of the present invention does not need to be understood in the literal meaning of the term, i.e. a positive match of data can also be attained if a predetermined rule from an expert system is fulfilled in an appropriate manner. Moreover, the “matching” of data in the present sense can also be given if the compared data values are found to be below or above any particular threshold. While this particular threshold can be a fixed value, it would also be imaginable to use a dynamic threshold value, determined based on past data or health profile of the user.

To this end, at least one communication module (not represented in FIG. 3) is also provided in the central unit 4. Each one of these communication modules can represent different data connection modules such as wireless data connection modules for transmitting data over a GPRS, UMTS, LTE, Bluetooth, WiFi, or any other wireless technology, or any wired data connection modules suitable for transmitting data over a wired technology such as Ethernet. The communication modules can in particular also comprise interfaces for connecting with a normal voice connection (to this end, it is also possible to use an IVR system at the central unit 4), a fax interface, an e-mail interface or any other suitable communication interface.

As an example, if the database 46a at the analyzing module 42 (or the separate database 46) contain stored data for triggering a smoke (or fire) alarm, and if the smoke sensor 21 detects the presence of smoke and transmits these data to the central unit 4 over the corresponding data connection 31, these data are received by the receiving module 41 and analyzed by the analyzing module 42 which will find out that the received data match the stored data. Therefore, the analyzing module 42 will forward these data to the triggering module 43 for triggering the corresponding smoke/fire alarm. In this particular case, the triggering module 43 will use the corresponding communication module(s) (e.g. a data connection over a GPRS wireless network) for sending an appropriate message and for informing the fire brigade that a fire has been detected. The data transmitted to the fire brigade can in particular comprise the location of the central unit 4, but also the nature of the detected smoke or other information that can be useful to the fire brigade. Also, the same alarm can be triggered simultaneously by different communication interfaces, e.g. using a GSM short messaging service (SMS), a fax message and a phone call using an IVR system. A skilled person will easily find out that different combinations of particular communication means can be used for different alarms.

On the other hand, if the data received by the receiving module 41 do not match data stored in the analyzing module 42, the analyzing module 42 can forward data to central processing equipment 6 (represented in FIG. 2). To this end, the central unit 4 is connected to the central processing equipment 6 over a second data connection 51. This second data connection 51 can also be any suitable wireless or wired data connection, in particular a GPRS, UMTS or LTE connection. Also, it is imaginable to use a data connection transmitting data over a local or global network 52 such as Intranet or Internet. The central processing equipment 6 can be a server comprising at least one module able to receive and analyze data received from the central unit 4 over the second data connection 51. Of course, the central processing equipment 6 can also be any distributed infrastructure, including a cloud solution.

Coming back to the central unit 4 represented in FIG. 3, it further comprises at least one physical interface 47, 48, 49. These physical interfaces 47, 48, 49 (which can be any suitable interface such as button, lever, pressure sensor or similar) can be used for manual triggering of predetermined alarms. For instance, the central unit 4 can comprise a “standard” emergency button 47 which can be used by the user of the system according to the present invention in order to trigger predetermined alarms. For example, pressing the emergency button 47 can result in the same process as described above in the case when the analyzing module 42 detects matching data. In particular, the corresponding information is sent from the emergency button 47 to the triggering module 43 which will then use a suitable communication module (e.g. a data connection over a LTE wireless network) for sending an appropriate message and for informing a supervising person about the particular emergency situation. On the other hand, the physical interface 48 can trigger a regular phone call over the corresponding voice connection to a predetermined phone number (for example to the general emergency number of the police, fire brigade or medical services). In this way, the central unit 4 can also be used as standard emergency equipment in a known way (i.e. with users used to standard emergency equipment).

In FIG. 3, the central unit 4 further comprises a timer module 44. The timer module 44 is basically used for saving energy at the central unit 4. In particular, the timer module 44 can be programmed in such a way that the central unit 4 forwards data to the central processing equipment 6 only at regular time intervals (e.g. every five, ten or fifteen minutes). Of course, other time intervals are also possible. However, the timer module 44 can also be used in another manner, in particular for determining the appropriate time for forwarding the data to the central processing equipment 6. In other words, the central unit 4 according to the present invention can use the timer module 44 to detect the appropriate time for forwarding data to the central processing equipment 6. As already mentioned above, the timer module 44 could for example be used for analyzing data received from the sensors 21, 22, 23, . . . . As an example, when a fridge door sensor 21 detects the open state of the fridge door which is transmitted to the central unit 4, the timer module 44 can be used for transmitting the information to the triggering module 43 only after a predetermined time (e.g. 30 seconds or similar) have expired. In other words, the alarms are only triggered if this state of the fridge door persists for a certain time. Other similar applications of the timer module 44 are apparent to a skilled person based on this description, in particular a case in which the timer module 44 is used to control the use of the physical interfaces 47, 48, 49. For instance, an emergency phone call (which is triggered when the user presses a physical interface) could first be delayed for a certain time which is used to verify the emergency situation using information received from at least one of the sensors 21, 22, 23, . . . .

As can be seen in FIG. 4 which is a schematic view of the central processing equipment 6, this central processing equipment 6 typically further comprises a receiving module 65 which receives data from the central unit 4 over the second data connection 51. Of course, it is also imaginable to have more than one receiving module 65, depending on the type of data transmitted and/or transmission technology. Furthermore, the central processing equipment 6 also comprises two databases 61, 62, namely a first database 61 for storing data received from the central unit 4 and a second database 62 for storing predetermined reference data. In this respect, this second database 62 is similar to the databases 46a and 46 of the central unit 4, but the data stored in each one of these databases can of course be completely different. Also possible is omitting one or more of the databases 46a, 46, 61, 62 and transferring their functions to another of the databases.

The central processing equipment 6 further comprises an analyzing module 62. This analyzing module 62 of the central processing equipment 6 is used for comparing the data stored in the first database 61 with the data stored in the second database 62 and for triggering predetermined alarms if the compared data match each other. To this end, the triggering module 64 and all necessary communication interfaces (not represented) are also provided. Again, this function of the analyzing module 63 and of the triggering module 64 is similar to the function of the analyzing module 42 and of the triggering module 43 of the central unit 4. However, the difference between all these different modules resides mainly in the type of data and the type of alarms which are triggered by each of them.

Preferably, the central unit 4 is in charge of urgent alarms, i.e. emergency alarms such as flood, fire, etc. If any one of the corresponding sensors 21, 22, 23, . . . detects corresponding information and transmits this information to the central unit 4, no further processing of data is necessary and the corresponding alarm can be triggered directly. In this way, no necessary time is lost before an alarm can be triggered, which can help save lives. However, the information received by the central unit 4 from the sensors 21, 22, 23, . . . and the information about the alarms triggered by the central unit 4 can still be transmitted to the central processing equipment 6 for further processing.

On the other hand, the central processing equipment 6 can in particular be in charge of triggering less urgent alarms, i.e. alarms which are not produced in connection with an emergency situation. These less urgent alarms are, in a general case, triggered using a combination of events gathered by multiple sensors over a given period of time. Furthermore, these less urgent alarms use behavior analysis methods described below.

As already mentioned above, the present invention concerns also a monitoring of changes in behavior of users and triggering alarms based on this information. As an example only, one embodiment of the system according to the present invention can comprise a stove sensor for detecting the on or off state of the cooking stove together with a door sensor connected to the fridge door. If the fridge door has been opened and closed after a certain time and the cooking stove has then been turned on, the corresponding sensors detect these situations and send the corresponding information to the central unit 4. The same happens after the cooking stove has been switched off. Since this information does not relate to an emergency situation (unless the stove in the kitchen has not been turned off after a predetermined maximum time), the central unit 4 does not detect any matching data in the databases 46a or 46, and transfers the received data to the central processing equipment 6. The central processing equipment 6 then stores the received data in the first database 61, and analyzes these data by comparing them with data stored in the second database 62. In this case, the fact that the fridge door has first been opened and closed and that the cooking stove has been switched on and then switched off indicates the fact that the user of the system has prepared a meal. Thus, this information will not lead to triggering of an alarm.

However, if the fridge door has not been opened and/or if the cooking stove has not been turned on for a certain predetermined time (e.g. during two or three days), the central processing equipment 6 will be able to realize that the user has not eaten sufficiently, and will then trigger the corresponding alarm. Again, this alarm can be of any type, for example a phone call to a supervisor and/or an e-mail to another person. A skilled person will of course be able to understand that any other combinations of sensors, alarms and appropriate communication means can be used as a function of the particular applications.

It is necessary to point out here that the different situations and the different alarms can be prioritized both in terms of time for triggering an alarm and in terms of alarm level. In other words, emergency situation (e.g. fire or flood) can be prioritized in the temporal sense, such that alarms corresponding to these situations are triggered automatically, without any delay. On the other hand, less urgent situations, for example the fact that the user has not moved during a certain period of time (which can be detected using the bed sensors) is a much less urgent alarm which can, if necessary or required, be delayed during a certain time (for example, an alarm can be triggered only after the user has not moved during more than 30 hours). On the other hand, the alarm levels can also be graduated such that very urgent alarms can require immediate response (for example if the system detects that the user has not turned off the water tap in the bath) while less urgent alarms can require only an intervention after a certain period of time. For example, a nurse can be requested to visit the user of the system within a certain period of time (such as 24 hours) if it is detected that he/she has not yet eaten the necessary meal.

Furthermore, the present invention also allows for a continuous monitoring of the users' behavior. To this end, the central processing equipment 6 can comprise a display module 63 for displaying data which are stored in the first database 61 of the central processing equipment 6 via a graphical user interface 7. This graphical user interface 7 can in particular be capable of being accessed by means of a web browser. Thanks to this particular feature of the central processing equipment 6, the data collected by the different sensors 21, 22, 23, . . . and transmitted to the central processing equipment 6 via the central unit 4 can be aggregated and then accessed by a supervisor (or any other authorized person) by means of an intuitive user interface.

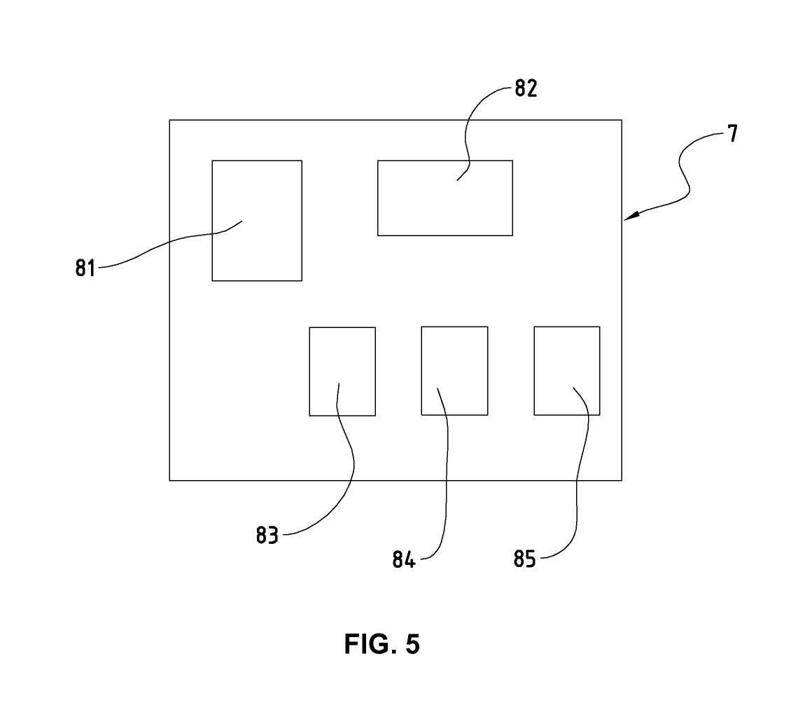

An example of such an interface is schematically illustrated in FIG. 5. The interface 7 can preferably comprise different graphical modules 81, 82, 83, . . . showing different data from the database 61. These data can comprise the general information about the user of the system, information about the different data captured by the different sensors 21, 22, 23, . . . , a history of all triggered alarms, etc. However, the present invention is also capable of aggregating the data and presenting them in a way which is particularly easily understandable.

In a particular, non limiting embodiment of the present invention, the received data can be aggregated according to their relevancy for three different categories of users' behavior, namely data relating to the mobility of the monitored person (e.g. has the user left the bed, has the user left the armchair, has the user left the apartment, how long is the distance that the user has covered during a particular time period, etc.), data relating to the nutrition status of the monitored person (e.g. has the user eaten anything during a particular time period, has the user also eaten warm meals during a particular time period, has the user drunk sufficiently during a particular time period, etc.), and data relating to the cognition of the monitored person (e.g. has the user forgotten to turn off the water tap, has the user forgotten to lock the door, etc.).

Each of these groups of aggregated data can be represented in a particular way in the graphical user interface 7. In particular, it is also possible to represent normal data values together with current data values and to make any differences between these values particularly visible to the supervisor. Finally, it must not be forgotten that alarms can also be triggered if particular values of any one of the aggregated data sets differ from the normal values.

Although the present disclosure has been described with reference to particular means, materials and embodiments, one skilled in the art can easily ascertain from the foregoing description the essential characteristics of the present disclosure, while various changes and modifications may be made to adapt the various uses and characteristics as set forth in the following claims.

1. System for an automated triggering and management of alarms, in particular in a home environment, comprising at least one sensor for collecting data and for transmitting the collected data over at least one first data connection to a central unit,
characterized in that the central unit comprises
at least one receiving module for receiving transmitted data and for forwarding the received data to an analyzing module, the analyzing module being capable of
comparing the received data with data stored in the analyzing module and
forwarding the received data to a triggering module for triggering at least one predetermined alarm as a function of the data received from the analyzing module if the received data matches data stored in the analyzing module, or
forwarding the received data to central processing equipment over a second data connection if the received data does not match data stored in the analyzing module.

2. System according to claim 1, characterized in that the central unit further comprises at least one physical interface for manual triggering of a predetermined alarm.

3. System according to claim 1, characterized in that the first data connection is a wireless data connection, in particular WiFi, ZigBee or Bluetooth.

4. System according to claim 1, characterized in that the second data connection is a wireless data connection, in particular a GPRS, UMTS or LTE connection.

5. System according claim 1, characterized in that the central unit comprises a timer module for determining the time for forwarding the received data to the central processing equipment.

6. System according to claim 1, characterized in that the central processing equipment comprises a first database for storing data received from the central unit and a second database for storing predetermined reference data.

7. System according to claim 6, characterized in that the central processing equipment comprises an analyzing module for comparing the data stored in the first database (61) with the data stored in the second database and for triggering at least one predetermined alarm if the compared data match each other.

8. System according to claim 5, characterized in that the central processing equipment comprises a display module for displaying at least part of data stored in the first database of the central processing equipment via a graphical user interface, in particular a graphical user interface capable of being accessed by means of a web browser.

9. Method for an automated triggering and management of alarms, in particular in a home environment, in which at least one sensor collects data and transmits the collected data over at least one first data connection to a central unit,
characterized in that
at least one receiving module of the central unit receives transmitted data and forwards the received data to an analyzing module, the analyzing module:
comparing the received data with data stored in the analyzing module and,
forwarding the received data to a triggering module for triggering at least one predetermined alarm as a function of the data received from the analyzing module if the received data matches data stored in the analyzing module, or
forwarding the received data to central processing equipment over a second data connection if the received data does not match data stored in the analyzing module.

10. Method according to claim 9, characterized in that a predetermined alarm is triggered manually by means of at least one physical interface of the central unit.

11. Method according to claim 9, characterized in that the first data connection is a wireless data connection, in particular a ZigBee, Bluetooth or WiFi connection.

12. Method according to claim 9, characterized in that the second data connection (51) is a wireless data connection, in particular a GPRS, UMTS or LTE connection.

13. Method according to claim 9, characterized in that the time for forwarding the received data to central processing equipment is determined by a timer module of the central unit.

14. Method according to claim 9, characterized in that data received from the central unit is stored in a first database of the central processing equipment and in that predetermined reference data are stored in a second database of the central processing equipment.

15. Method according to claim 14, characterized in that the data stored in the first database are compared with the data stored in the second database by an analyzing module of the central processing equipment and that at least one predetermined alarm is triggered if the compared data match each other.
